(19) United States
(12) Patent Application Publication
(10) Pub. No.: US 2025/0272732 A1
(43) Pub. Date: Aug. 28, 2025

(54) VISUAL SEARCH BASED REAL TIME E-COMMERCE SYSTEM AND METHOD WITH COMPUTER VISION

(71) Applicants: Ramakrishna Reddy PABBATHIREDDY, Hyderabad (IN); Niharika PABBATHIREDDY, Hyderabad (IN)

(72) Inventors: Ramakrishna Reddy PABBATHIREDDY, Hyderabad (IN); Niharika PABBATHIREDDY, Hyderabad (IN)

(21) Appl. No.: 18/589,486

(22) Filed: Feb. 28, 2024

(51) Int. Cl. G06Q 30/0601; G06V 10/764

(52) U.S. Cl. CPC G06Q 30/0627; G06Q 30/0609; G06V 10/764

(57) ABSTRACT

A visual search based real time e-commerce system and method with computer vision is disclosed. A visual search engine (150) of the said system draws item detection and classification (110) sub module to retrieve information from a remote database (118). The said item detection sub module (110) on the server having instructions, that when executed by a processor, cause operations to be performed, wherein the operations includes receiving at least one image (102) and/or a video uploaded (104) by a user using a mobile application to the said visual search engine (150). The visual search (150) engine requests vendors registered in the system to quote availability and a cost associated, payment method, and shipping options (124) to a preferred location of the said user. The real-time e-commerce system trained using deep learning models accurately identifies and classifies the objects, maps the object label set with its respective product category which in turn, creates product attributes to search vendors in the specific category in real-time.

### FIELD OF INVENTION

The present invention relates to a real time e-commerce system with computer vision and Artificial Intelligence (AI) to provide advanced visual search to connect partnered offline vendors in real time. More particularly, to a real time e-commerce system that automates tasks that the human visual system can do.

### BACKGROUND OF THE INVENTION

In present days people become very much concerned about selection of merchandise. The item attributes like size, color, brand, material etc., plays major role in buying the things. Above all the price of the product also plays key role. So, buying anything in present times includes too much waste of time. We have to search several shops and meet several vendors asking the needed item with attributes.

The prior art U.S. Pat. No. 8,611,919B2 deals with location based mobile e-commerce systems handling the vendors and buyers to restrict to specific network and selecting items through e-mails and mobile voice calls.

The prior art KR20070075363A deals with real time shopping mall and method to bargain the price with the only vendor selling through chatting or call. In this type there is no security and genuinity of the product or vendor.

The prior art U.S. Pat. No. 7,502,757 deals with to matching buyers and sellers in a marketplace accepts limit bids and offers into a central system. Periodically, an optimizing algorithm is executed to match buyers and sellers. The algorithm utilizes techniques to maximize global utility. After buyers and sellers are matched, a transaction price is calculated for each pairing. The transaction price is selected to ensure that each participant executes the transaction at that participant's best effective transaction price.

The prior art U.S. Pat. No. 8,732,030B2 deals with to providing merchandise items at a network site. According to an embodiment, an image of a merchandise item is obtained. The image is programmatically analyzed to determine information about the merchandise item. The information is used to generate a presentation that includes the merchandise item.

The prior art U.S. Pat. No. 8,732,030B2 deals with to provide services associated with an image is disclosed. The method includes receiving image data of an item of interest from a client device. The image data is used to identify a similar item from an image catalog based on the image data of the item. Attribute information associated with the similar item is retrieved and used to pre-populate a template. The pre-populated template is sent to the client device, and modified data from the client device is received in response, with the modified data resulting in a final template. A listing based on the final template is generated.

Therefore, there is dire need to develop a real time e-commerce system with computer vision & AI to provide advanced visual search to connect partnered offline vendors in real time

### BRIEF SUMMARY OF THE INVENTION

The following is a brief summary of subject matter that is described in greater detail herein. This summary is not intended to be limiting as to the scope of the claims.

Other features of the embodiments will be apparent from the accompanying drawings and from the detailed description that follows.

According to an aspect of the present invention, a visual search based real time e-commerce system is disclosed. The system comprises of a remote server and a database comprising a processor and a memory unit being configured to store an item recognition module that is executable by the processor. The real time e-commerce system automates tasks that the human visual system can do. The real time e-commerce system uses trained deep learning models to accurately identify objects and classify them based on the Image fed by the user.

In accordance with the aspect of the present invention, the system comprises of a mobile application configured on a mobile device of a user to search, acquire, store, upload images and/or videos of the items that a user wishes to search.

In accordance with the aspect of the present invention, wherein the said visual search engine draws item detection and classification sub module that creates an object label set.

In accordance with the aspect of the present invention, the object detection and classification sub module retrieve information from the remote database that stores items specific information along with Item Category.

In accordance with the aspect of the present invention, the object detection and classification sub module perform category mapping based on item categories and item attributes.

In accordance with the aspect of the present invention, the said visual search engine creates an order request after category mapping wherein the user is allowed to view, refine search and pursue details of a plurality of vendors interested in selling the item.

In accordance with the aspect of the present invention, the said visual search engine send requests to a plurality of vendors registered to the system to quote the availability and a cost associated, payment method, shipping options in the preferred location of the user.

In accordance with the aspect of the present invention, wherein the said real time e-commerce system allows user to review the sellers based on their rating, reviews, item availability and communicate with the vendors directly to perform buying of the product.

In accordance with the aspect of the present invention, wherein the said real time e-commerce system verifies the order details with confirmation of OTP received on a registered mobile number.

In accordance with the aspect of the present invention, the system using computer vision process, analyze, and make sense of visual data (images and/or videos) in the same way that humans do.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 illustrates whole architecture of the real time e-commerce system and method, according to an exemplary embodiment of the present invention;

FIG. 2 illustrates creating an account and registering mobile number, according to an exemplary embodiment of the present invention;

FIG. 3 illustrates a home page of the mobile application, according to an exemplary embodiment of the present invention;

FIG. 4 illustrates uploading an image and/or a video and selecting item attributes to conduct a search, according to an exemplary embodiment of the present invention;

FIG. 5 illustrates requesting the order from registered vendors, according to an exemplary embodiment of the present invention;

FIG. 6 illustrates vendor details with item attributes and cost, according to an exemplary embodiment of the present invention;

FIG. 7 illustrates a profile page of vendors, according to an exemplary embodiment of the present invention;

FIG. 8 illustrates a page with latest orders, according to an exemplary embodiment of the present invention;

FIG. 9 illustrates Feedback pages for vendor and product, according to an exemplary embodiment of the present invention;

FIG. 10 illustrates the flow of system from image capturing to real time order management, according to an exemplary embodiment of the present invention;

FIG. 11 illustrates the flow chart depicting the flow process followed by the visual search, according to an exemplary embodiment of the present invention;

FIG. 12 illustrates the flow chart depicting the flow process followed by the category mapping, according to an exemplary embodiment of the present invention;

FIG. 13 illustrates the flow chart depicting the flow process followed by the vendor search, according to an exemplary embodiment of the present invention.

### DETAILED DESCRIPTION OF THE INVENTION

The description that follows is presented to enable one skilled in the art to make and use the present invention and is provided in the context of a particular application and its requirements. Various modifications to the disclosed embodiments will be apparent to those skilled in the art, and the general principles discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

It will be understood that in the event parts of different embodiments have similar functions or uses, they may have been given similar or identical reference numerals and descriptions. It will be understood that such duplication of reference numerals is intended solely for efficiency and ease of understanding the present invention and are not to be construed as limiting in any way, or as simplifying that the various embodiments themselves are identical.

The terminology used herein is for the purpose of describing particular example embodiments only and is not intended to be limiting. As used herein, the singular forms “a,” “an” and “the” “said” may be intended to include the plural forms as well, unless the context clearly indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, and components thereof.

Embodiments described herein enable programmatic detection and/or identification of various types and classes of objects from images, including objects that are items of commerce or merchandise. Among the numerous embodiments described herein, embodiments include (i) systems and methods for detecting and analyzing images; (i) systems and methods searching for images using image data, text data, features, and non-textual data; (iii) user-interface and features thereof for enabling various forms of search on a collection or database of analyzed images; (iv) e-commerce applications for enabling visual, non-textual and visually aided searches of merchandise items; and (v) retrieval and analysis of images from third-party sites and network locations. Embodiments described herein further include components, modules, and sub-processes that comprise aspects or portions of other embodiments described herein.

Embodiments described herein provide for a system for creating a data collection of recognized images. The system includes an image analysis module that is configured to programmatically analyze individual images in a collection of images in order to determine information about each image in the collection. The system may also include a manual interface that is configured to (i) interface with one or more human editors, and (ii) displays a plurality of panels concurrently. Individual panels may be provided for one or more analyzed images, and individual panels may be configured to display information that is at least indicative of the one or more images of that panel and/or of the information determined from the one or more images. Additionally, the manual interface enables the one or more human editors to view the plurality of panels concurrently and to interact with each of the plurality of panels in order to correct or remove any information that is incorrectly determined from the image of that panel.

One or more embodiments enable image analysis of content items that include image. Among other applications, the analysis of such content items (including images or images with text and/or metadata) enables the use of content or image based searching. In one embodiment, a search query may be derived from image data, or values for image data.

As used herein, the term “image data” is intended to mean data that corresponds to or is based on discrete portions of a captured image. For example, with digital images, such as those provided in a JPEG format, the image data may correspond to data or information about pixels that form the image, or data or information determined from pixels of the image. Another example of “image data” is signature or other non-textual data that represents a classification or identity of an object, as well as a global or local feature.

Embodiments described herein generally require the use of computers, including processing and memory resources. For example, systems described herein may be implemented on a server or network service. Such servers may connect and be used by users over networks such as the Internet, or by a combination of networks, such as cellular networks and the Internet. Alternatively, one or more embodiments described herein may be implemented locally, in whole or in part, on computing machines such as desktops, cellular phones, personal digital assistances or laptop computers. Thus, memory, processing and network resources may all be used in connection with the establishment, use or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Computers, terminals, network enabled devices (e.g. mobile devices such as cell phones) are all examples of machines and devices that utilize processors, memory, and instructions stored on computer-readable mediums. According to an exemplary embodiment of the present invention, a visual search based real time e-commerce system with computer vision to connect partnered vendors in real time is disclosed. The real time e-commerce system automates tasks that the human visual system can do. The real time e-commerce system trained using deep learning models, accurately identifies and classifies the objects that are been fed by the user.

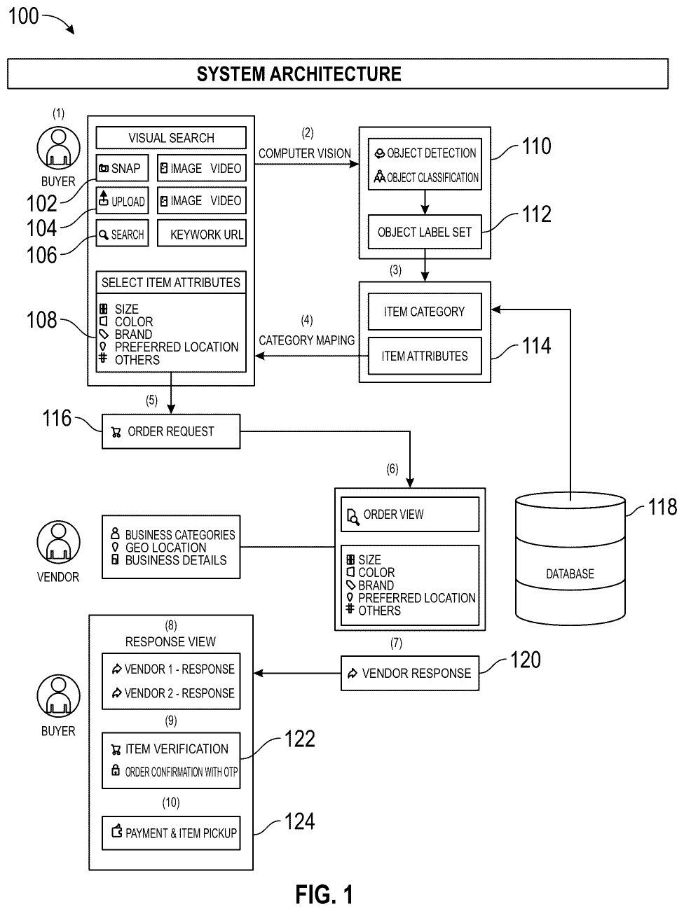

Referring to the figures, FIG. 1 illustrates the system (100) comprises a remote server and a database (118) comprising a processor and a memory unit being configured to store an item recognition module that is executable by the processor. The processor comprises of an item recognition (110) module that detects item categories and item attributes like size, color, brand (108).

In accordance with the exemplary embodiment of the present invention, the real time e-commerce system runs on a mobile application configured on a user's mobile device to search, (106) acquire, store, upload (104) images/snap (102) and/or videos of the items that a user wishes to search (106), and retrieve sellers matching the search (106) criteria in real time.

In accordance with the exemplary embodiment of the present invention, the visual search engine draws a request to item detection and classification (110) sub module present in the processor that creates an object label set (112). It retrieves information from the said remote database (118) that stores items specific information along with product Category and the vendors registered to sell the items. It performs category mapping by way of item categories and item attributes (114).

In accordance with the exemplary embodiment of the present invention, the category mapping (4) involves mapping of item attributes like at least a material, a size, color, brand, preferred location (108) of the user. The said visual search (150) engine creates an order request (116) (5) after category mapping (4) wherein the user is allowed to view, refine search (106) and pursue details of a plurality of vendors (120) interested in selling the item.

In accordance with the exemplary embodiment of the present invention, the processor executes the operations like receiving at least one image/snap (102), detection of item and classification (110) sub module (2) that creates an object label set (112), retrieving information from the said remote database (118), performing category mapping (4) by way of item categories and item attributes (114).

In accordance with the exemplary embodiment of the present invention, the said visual search (150) engine send requests to the vendors registered to the system to quote the availability and a cost associated, payment method and shipping options (124) in the preferred location of the user.

In accordance with the exemplary embodiment of the present invention, the visual search system allows user to review the vendors based on their rating, reviews, item availability and communicate with the vendors directly to perform buying of the product.

In accordance with the exemplary embodiment of the present invention, the vendors provide each other's information in real time to select a more secure seller to the buyer, thereby increasing the purchase safety. After sending order request (116) by verifying the order details with confirmation of OTP received on a registered mobile number (122).

In accordance with the exemplary embodiment of the present invention,

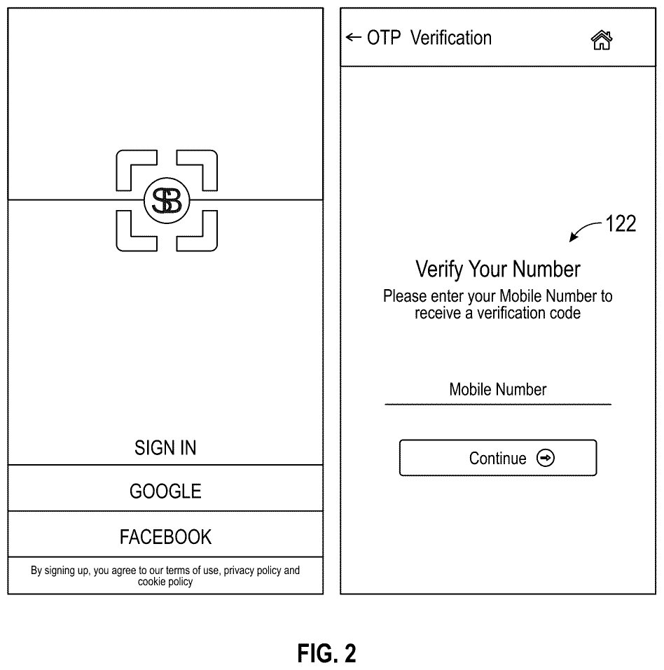

FIG. 2 illustrates creating an account in the mobile application configured to mobile device. Registering the account through mail and contact details. The next step in creating account is verification of mobile number through OTP (one time password) verification (122).

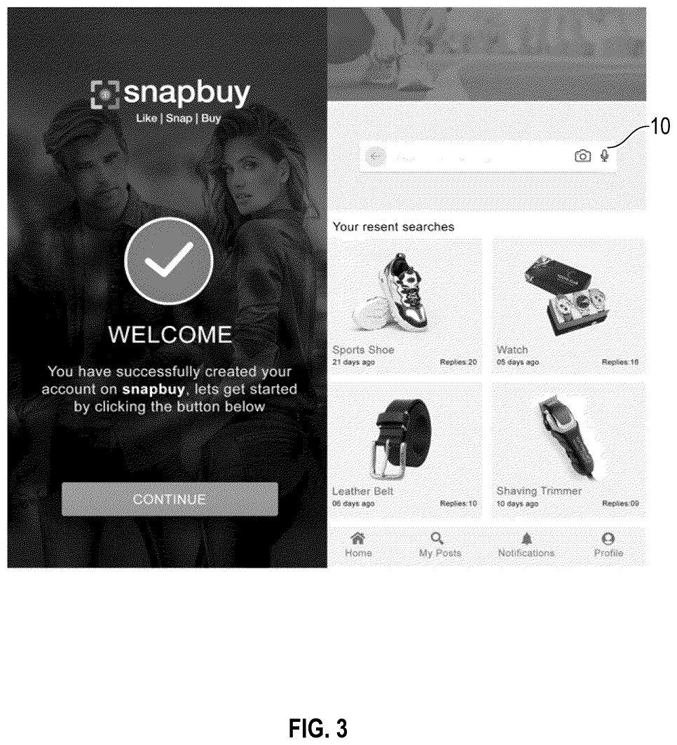

FIG. 3 illustrates home page of the mobile application having options search (106), notifications, profile. The home page is meant for showing suggestions based on recent searches.

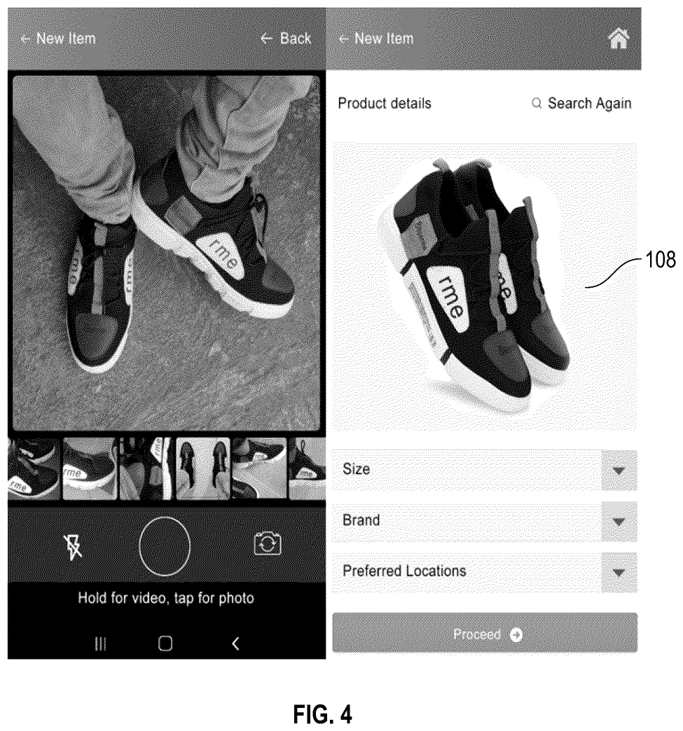

FIG. 4 illustrates how the visual search (150) engine is working by uploading (104) a snap/image (102) of item. The processor detecting item attributes (108) and showing product details.

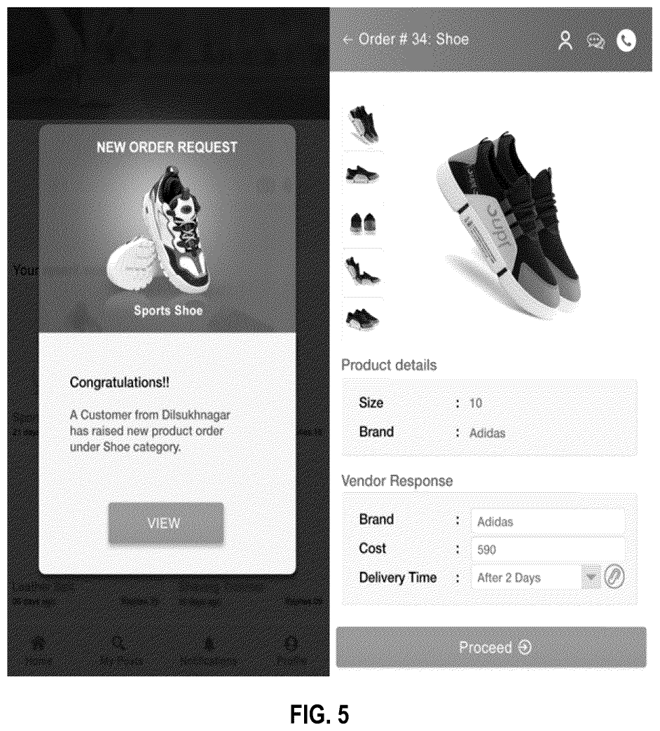

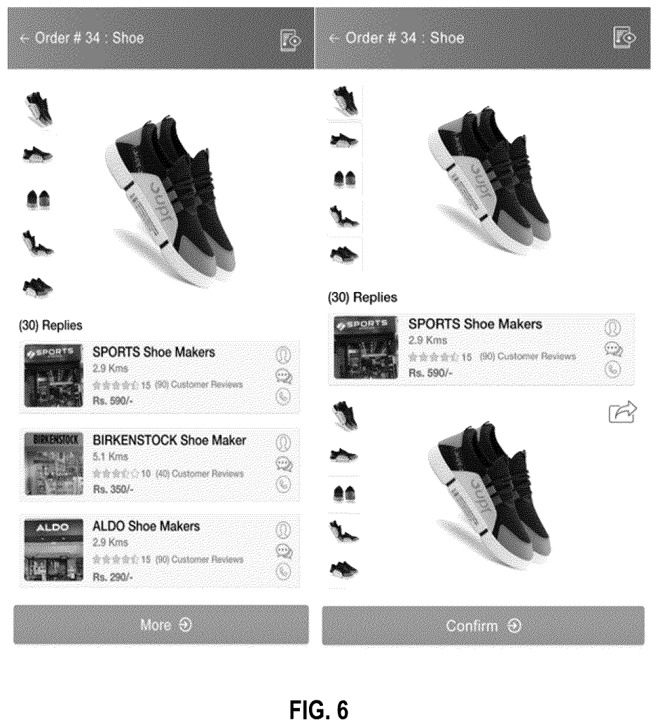

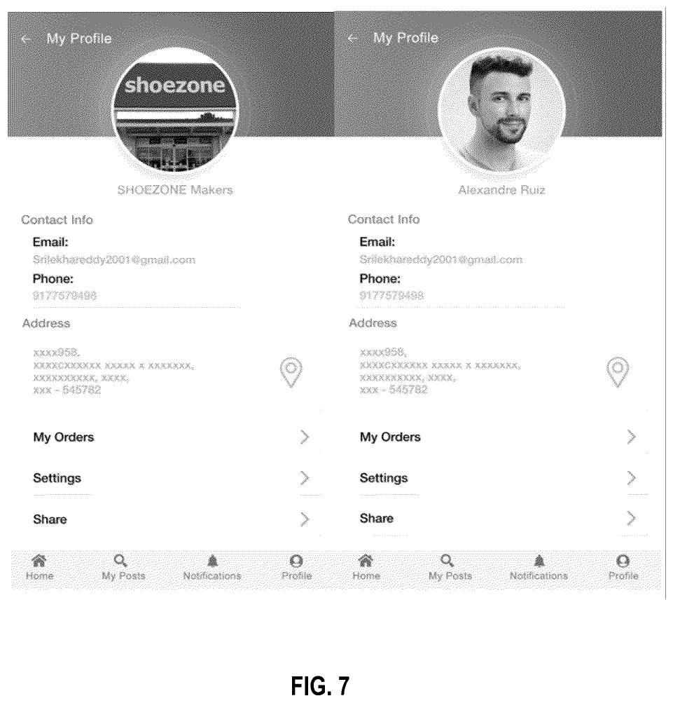

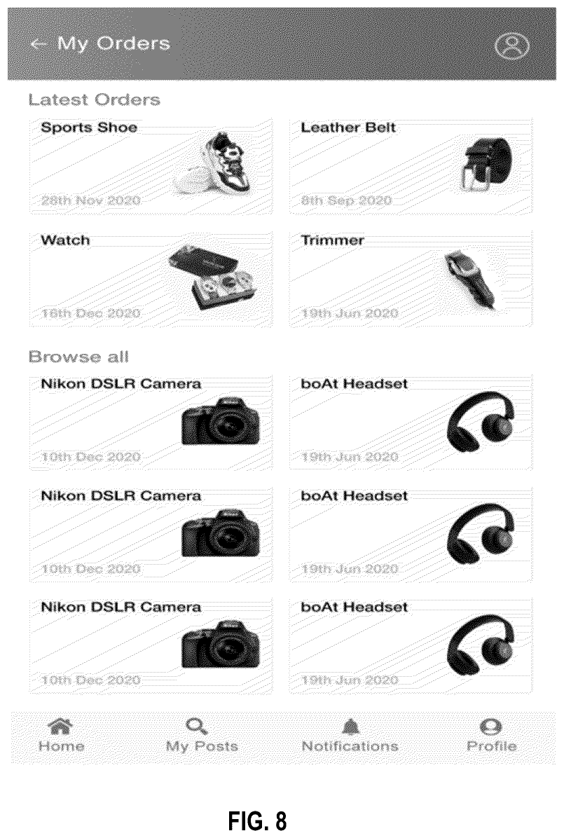

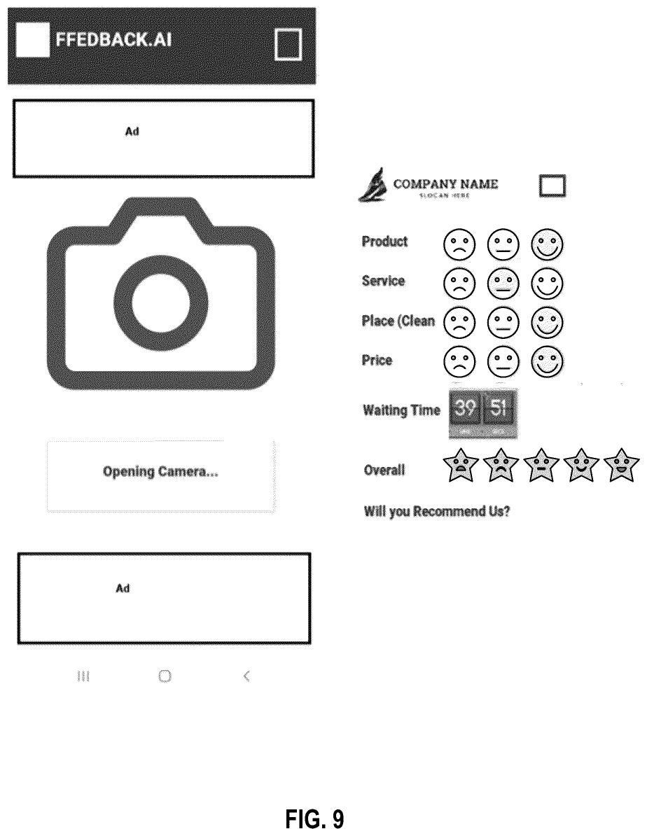

FIG. 5 illustrates sending order request and next page showing vendor responses stating brand, cost, and delivery time and product details. FIG. 6 illustrates vendor details and different vendors also selling identical items with details. FIG. 7 illustrates different vendor's details like email, phone number, address. FIG. 8 illustrates my orders page showing latest orders from the logged in profile and suggestions based on recent searches. FIG. 9 illustrates feedback forms for vendor as well as the product, service, place, price, waiting time, overall rating.

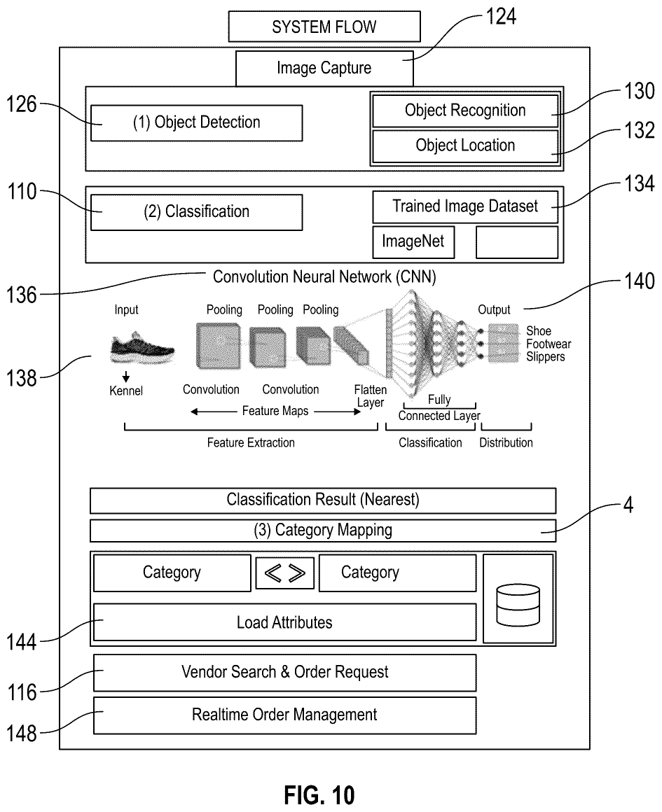

FIG. 10 illustrates the flow of system from image capturing (124) to real time order management explaining the image capturing module (124) comprising object detection (126) and classification (110) sub modules. The object detection sub module (126) includes object recognition (130) and object localization (132). The classification sub module (110) includes trained image dataset (134).

The convolution neural network (136) works on taking input image (138) and processing it for feature extraction. After completion of feature extraction the classification step is initiated and classifies for the resultant output. The next stage after output (140) is category mapping (4) and loading attributes (144). The attributes loading followed by the step searching vendors and placement of order request (116). After placing the order request (116) the real time order management (148).

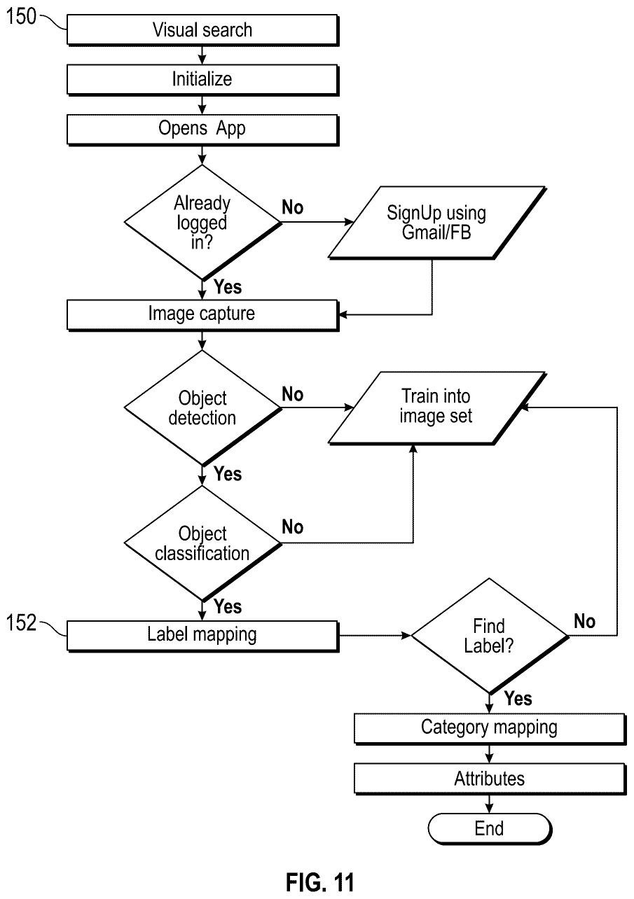

FIG. 11 illustrates the flow chart depicting the flow process followed by the visual search engine (150). The initialization of the application software and logging into account or signing into new account. The image of the product or item is captured and the object detection module (126) comes into play and object classification is done by label mapping (152). The next step in the flow process is category mapping (4) and inputting attributes.

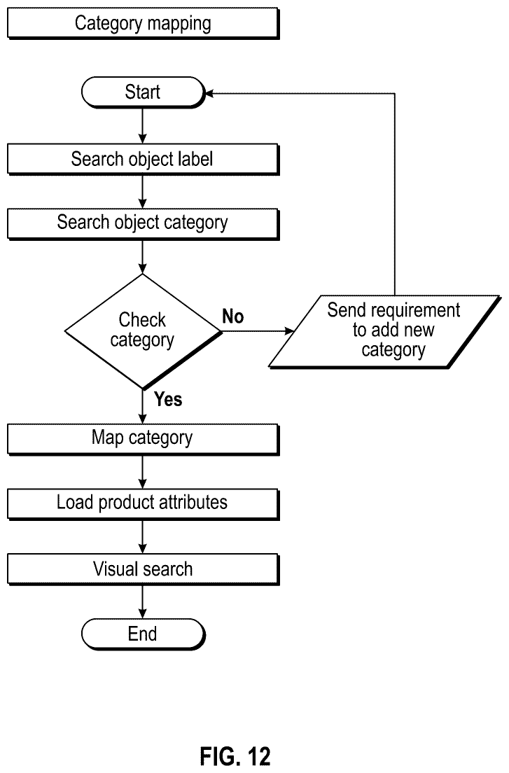

FIG. 12 illustrates the flow chart depicting the flow process followed by the category mapping (4). After classification and attributes inputting the category mapping (4) comes into play. Searching the object label and object categories. Check for the category and addition of new category. The module maps the category and loads product attributes for visual searching (150).

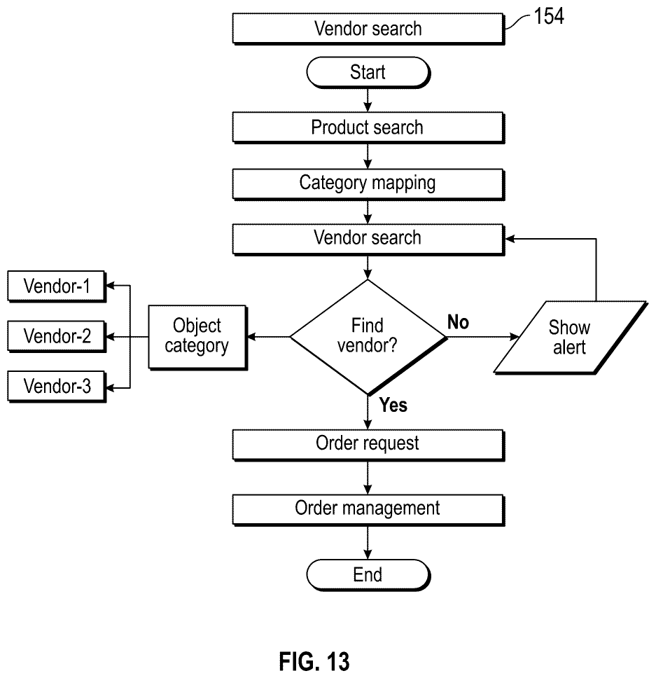

FIG. 13 illustrates the flow chart depicting the flow process followed by the vendor search (154). The vendor search (154) module starts operating after the product search and mapping its category. The module starts searching for vendors. It shares alert to the vendors and alerts the vendors after categorizing the object. After the completion of the request for order is placed. The real time order management (148) comes into vendor search (154) play.

It is to be understood that the specific embodiment of the present invention that are described herein is merely illustrative of certain applications of the principles of the present invention. It will be appreciated that, although an exemplary embodiment of the present invention has been described in detail for purposes of illustration, various modifications may be made without departing from the spirit and scope of the invention. Therefore, the invention is not to be limited except as by the appended claims.

1. A method of buying items using a visual search (150) based real time e-commerce system, wherein the method comprises steps of:
receiving at least one image/snap (102) and/or video uploaded (104) by the user using the said mobile application by a visual search engine (150);
drawing a request from the said visual search (150) engine to an item detection and classification (110) sub module (2) that creates an object label set (112);
retrieving information from the said remote database (118) that stores items specific information and the sellers registered to sell the items, by the object detection (126) and classification (110) sub module;
performing category mapping (4) by way of item categories and item attributes (114) by the said object detection (126) and classification (110) sub module;
mapping of item attributes like at least a size, a color, a brand, a preferred location (108) of the user by way of category mapping (4);
creating an order request (116) (5) after category mapping (4) wherein the user is allowed to view, refine search (106) and pursue details of a plurality of vendors interested in selling the item;
sending requests to a plurality of vendors registered to the system to quote the availability and a cost associated, payment method and shipping (124) options in the preferred location of the user; and
the said real time e-commerce system allows user to review the sellers based on their rating, reviews, item availability and communicate with the vendors directly to perform buying of the product.

2. The method as claimed in claim 1, wherein the search result determining a set of images of items of 5 the given category that have visual attributes (108) that are similar to the specified visual attributes (108).

3. The method as claimed in claim 1, wherein vendors can provide each other's information in real time to select a more secure seller to the vendor, thereby increasing the purchase safety.

4. The method as claimed in claim 1, wherein after sending order request (116) by verifying the order details with confirmation of OTP received on a registered mobile number (122).

5. The method as claimed in claim 1, wherein a feedback is taken from registered users based on product, service, place, price, waiting time and overall ranking of the vendor.

6. A visual search (150) based real time e-commerce system, wherein the system comprises of:
a remote server and a database (118) comprising a processor, a memory in communication with the said processor, the said memory being configured to store an item recognition module that is executable by the said processor;
a mobile application configured on a mobile device to search, (106) acquire, store, upload (104) images (102) and/or videos of the items that a user wishes to search, (106) and retrieve sellers matching the search (106) criteria in real time;
the real time e-commerce system comprises of an item recognition (110) module comprising of a visual search (150) engine that receives at least one image/snap (102) and/or video uploaded (104) by the user using the said mobile application;
the said visual search (150) engine draws a request to item detection and classification (110) sub module that creates an object label set (112);
the object detection (126) and classification (110) sub module retrieve information from the said remote database (118) that stores items specific information and the sellers registered to sell the items;
the object detection (126) and classification (110) sub module perform category mapping (4) by way of item categories and item attributes (114);
the said category mapping (4) involves mapping of item attributes like at least a material, a size, a color, a brand, a preferred location (108) of the user;
the said visual search (150) engine creates an order request (116) (5) after category mapping (4) wherein the user is allowed to view, refine search (106) and pursue details of a plurality of vendors (120) interested in selling the item;
the said visual search (150) engine send requests to a plurality of vendors registered to the system to quote the availability and a cost associated, payment method and shipping options (124) in the preferred location of the user; and
the real-time e-commerce system trained using deep learning models accurately identifies and classifies the objects, maps the object label set with its respective product category which in turn, creates product attributes to search vendors in the specific category in real-time.

7. The system as claimed in claim 6, wherein the said real time e-commerce system allows user to review the vendors based on their rating, reviews, item availability and communicate with the vendors directly to perform buying of the product.

8. The system as claimed in claim 6, wherein the system by use of computer vision, automates the tasks that the human visual system can do.

9. The system as claimed in claim 6, wherein the system trained using deep learning models, accurately identifies and classifies the objects that are been fed by the user.

10. The system as claimed in claim 6, the object detection (126) and classification (110) sub module perform category mapping (4) by searching the object label as well as category for category mapping (4) and to load attributes.

11. The system as claimed in claim 6, the visual search engine (150) configures vendor search (154) module to request plurality of vendors registered to the system to perform object categorization.
